(19) United States
(12) Patent Application Publication
(10) Pub. No.: US 2011/0307323 A1
(43) Pub. Date: Dec. 15, 2011

(54) CONTENT ITEMS FOR MOBILE APPLICATIONS

(75) Inventors: Christina Kuhn, Mountain View, CA (US); Deepak Chandra, Mountain View, CA (US)

(73) Assignee: Google Inc., Mountain View, CA (US)

(21) Appl. No.: 12/813,139

(22) Filed: Jun. 10, 2010

(51) Int. Cl. G06Q 30/00; G06F 17/30; G06Q 10/00

(52) U.S. Cl. 705/14.42; 705/14.45; 705/14.64; 707/770; 707/E17.014

(57) ABSTRACT

This specification relates to content presentation. In general, one aspect of the subject matter described in this specification can be embodied in methods that include actions of receiving a request to serve a content item to an application on a mobile device, the application being associated with one or more categories; for each of a plurality of content items in a collection of content items, identifying a performance signal for the content item, the performance signal representing the performance of the content item when served to one or more other mobile devices running the application and one or more other applications associated with one of the one or more categories; selecting, using one or more processors, a first content item from the plurality of content items based on the performance signals of the plurality of content items; and providing the first content item to the application on the mobile device.

### BACKGROUND

This specification relates to content presentation.

Advertisers provide advertisements in different forms in order to attract consumers. An advertisement (“ad”) is a piece of information designed to be used in whole or in part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a web page or a mobile application, as an impression. An advertising system can serve an ad to an application on a mobile device, for example, in response to the user running the application. If a user selects the presented ad (e.g., by “clicking” the advertisement, shaking the mobile device, or the like), the user is generally taken to another location associated with the ad, for example, to another, particular web page.

A particular user action associated with an ad can be referred to as a conversion. A conversion can be online or offline. An example of an offline conversion is when a user views an ad online for a particular product and then purchases the item at an offline retail store.

### SUMMARY

In general, one aspect of the subject matter described in this specification can be embodied in methods that include actions of receiving a request to serve a content item to an application on a mobile device, the application being associated with one or more categories; for each of a plurality of content items in a collection of content items, identifying a performance signal for the content item, the performance signal representing the performance of the content item when served to one or more other mobile devices running the application and one or more other applications associated with the category; selecting, using one or more processors, a first content item from the plurality of content items based on the performance signals of the plurality of content items; and providing the first content item to the application on the mobile device. Other embodiments of this aspect include corresponding systems, apparatus, and computer program products.

These and other embodiments can optionally include one or more of the following features. The first content item is an advertisement. For at least one content item, the performance signal is based on one or more of: an impression rate, a click-through rate, or a conversion rate. For at least one content item in the collection, determining that there is insufficient data for a performance signal for the content item and excluding the content item from selection of the first content item.

The performance signal is based on a weighted function of the performance of the content item when served to the other mobile devices running the application and the performance of the content item when served to the other applications associated with the category. The weighted function is based on how much data is available regarding the performance of the content item when served to the other mobile devices running the application.

The application is associated with first and second categories. The performance signal is based on a weighted function of the performance of the content item when served to one or more first applications associated with the first category and one or more second applications associated with the second category. The weighted function is based on how much data is available regarding the performance of the content item when served to the first applications and the second applications.

The one or more categories are related to types of content presented by the application. The actions further include identifying the one or more categories using an application store, where the one or more categories are provided by an application developer to the application store for the application.

The actions further include identifying a keyword associated with the request; determining one or more candidate content items using the keyword; and modifying a score of each candidate content item using the performance signal, where selecting the first content item includes selecting the first content item from the candidate content items using the scores for the candidate content items. The actions can further include identifying a keyword associated with the request; and determining one or more candidate content items using the performance signal.

Particular embodiments of the invention can be implemented to realize one or more of the following advantages. Ads can be targeted to applications on mobile devices using performance signals, including application-specific performance signals and application category performance signals. Ad targeting can be improved so that users see more relevant ads and advertisers realize higher returns on their advertising expenses. Ad targeting can be performed using performance signals while maintaining user privacy.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example content presentation system.

FIG. 2 illustrates an example ad system for serving ads to mobile applications.

FIG. 3 shows a table illustrating an example collection of performance signals.

FIG. 4 is flow chart of an example process for selecting an ad for a mobile application using performance signals.

FIG. 5 is a flow chart of an example process for adjusting scores of candidate ads to provide to a mobile application using weighted performance signals.

Like reference numbers and designations in the various drawings indicate like elements.

### DETAILED DESCRIPTION

Advertisers seek to have content items (e.g., ads) presented to users likely to be interested in the content items. For example, content items can be targeted to users based on an application that the user is using on a mobile device. In particular, content items can be selected for a mobile device application based on performance scores for the content items when served to that application or applications in the same category as that application.

While reference will be made below to advertising systems and processes, other forms of content including other forms of sponsored content can be managed and presented in accordance with the description below.

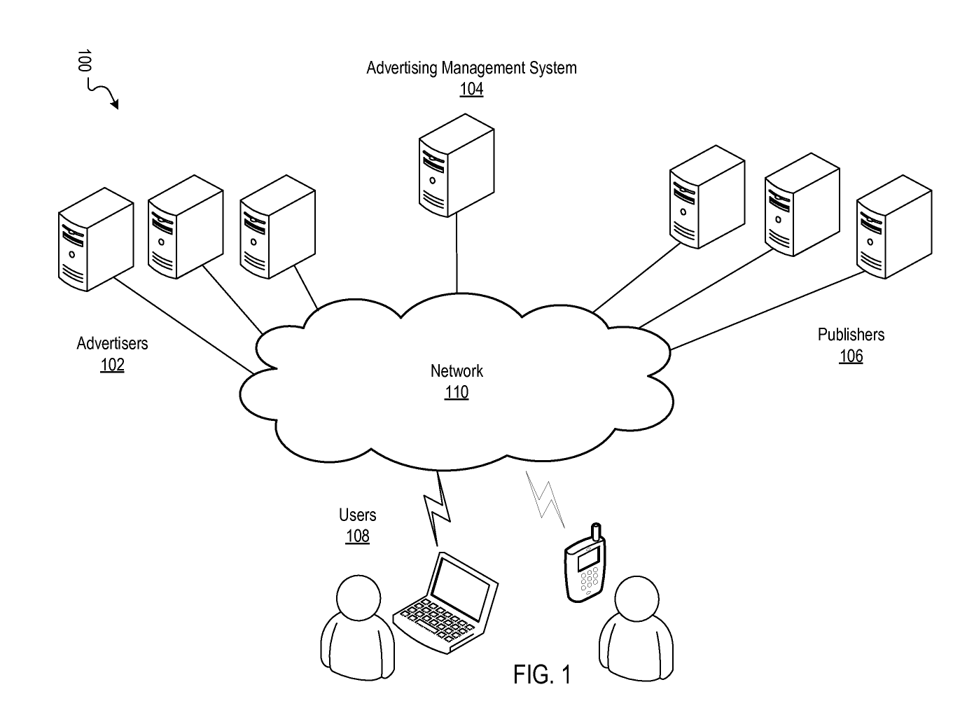

FIG. 1 is a block diagram of an example content presentation system 100. A network 110, such as a local area network (LAN), wide area network (WAN), the Internet, one or more telephony networks or a combination thereof, connects advertisers 102, an advertising management system 104, publishers 106, and users 108.

In some implementations, one or more advertisers 102 can directly, or indirectly, enter, maintain, and track ad information in an advertising management system 104. Though reference is made to advertising, other forms of content, including other forms of sponsored content, can be delivered by the system 104. The ads can be in the form of graphical ads, such as banner ads, text only ads, image ads, barcode ads (e.g., ads that include one or more barcodes for use in ad redemption), audio ads, video ads, ads combining one or more of any of such components, and so on. The ads can also include embedded information, such as links, meta-information, machine executable instructions, and the like.

One or more publishers 106 can submit requests for ads to the system 104. The advertising management system 104 responds by sending ads to the requesting publisher 106 for placement on, or association with, one or more of the publisher's content items (e.g., web properties). Example web properties can include web pages, television and radio advertising slots, or print media space. Web properties can appear in applications for mobile devices.

An example publisher 106 is a mobile application developer. A mobile application is an application specifically designed for operation on a mobile device (e.g., smartphones that can be used the users 108). The mobile application can also include ads positioned within the content of the mobile application. The ads can be received from the advertising management system 104 for placement in the mobile application when accessed by a user (e.g., when a particular page of a mobile application is loaded on the mobile device).

In some implementations, mobile applications submit requests for ads to the advertising management system 104. The advertising management system 104 responds by sending relevant ads to the requesting application to present to a user. For example, if an application is sports-related, the advertising management system 104 can provide sports-related ads to the mobile application.

In some implementations, the advertising management system 104 includes an auction process to select ads from the advertisers 102. For example, the advertisers 102 can be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

Entities such as users 108 and advertisers 102 can provide usage information to the advertising management system 104, for example, whether or not a conversion (e.g., a purchase or other interaction) or a click-through related to an ad (e.g., a user has selected an ad) has occurred. This usage information can include measured or observed user behavior related to ads that have been served. In some implementations, the advertising management system 104 performs financial transactions, for example, crediting the publishers 106 and charging the advertisers 102 based on the usage information.

The advertising management system 104 determines performance signals for ads. Performance signals are numeric scores indicating how an ad has performed in a certain context or contexts. Examples of performance signals for an ad include an impression rate, a click-through rate, a conversion rate (online, offline, or both), and so on. A click-through rate is a rate of selection of an ad. A user can select the ad by, e.g., clicking on it, making a gesture on a touch pad, shaking the mobile device, and so on. Examples of contexts for performances signals include performance when served to a particular mobile application, performance when served to applications in a category of mobile applications, performance when served in response to a particular keyword, performance during a certain time of day, and so on.

An application performance signal is a performance signal for a particular ad when served to users of a particular application. A category performance signal is a performance signal for a particular ad when served to applications associated with a particular category.

The advertising management system 104 selects ads for mobile applications based on performance signals for the ads. For example, in some implementations, the advertising management system 104 selects ads for a mobile application based on those ads click-through rate or conversion rate when served to the mobile application or applications in a category shared with the mobile application.

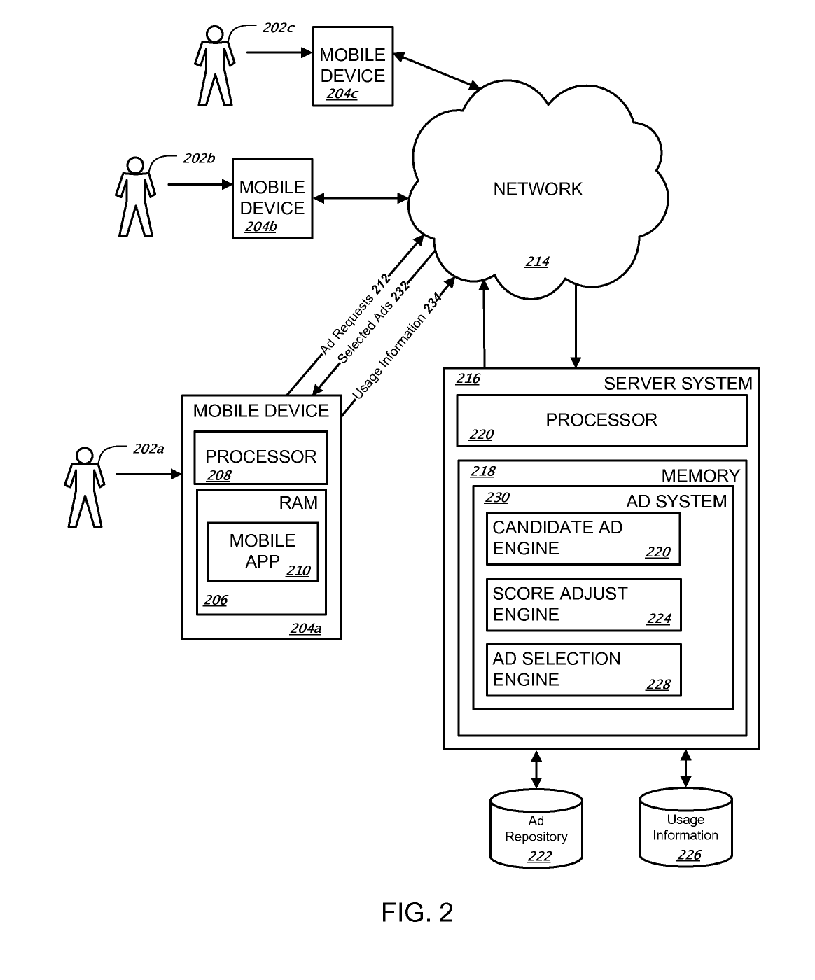

FIG. 2 illustrates an example ad system 230 for serving ads to mobile applications. The ad system can be implemented in an Internet, intranet, or other client/server environment. Although several components are illustrated, there may be fewer or more components in the ad system 230. Moreover, the components can be distributed on one or more computing devices connected by one or more networks or other suitable communication mediums.

User 202a, 202b, and 202c (collectively users 202a-c) interact with the ad system 230 through a respective mobile device 204a, 204b, and 204c (collectively mobile devices 204a-c). For example, the mobile devices 204a-c can be portable computers or smartphones within a local area network (LAN) or wide area network (WAN) or using a cellular network. As an example, the mobile device 204a generally includes a random access memory (RAM) 206 (or other memory and/or a storage device) and a processor 208. The processor 208 is structured to process instructions on the mobile device 204a. The processor 208 is a single or multi-threaded processor having one or more processor cores, for example. The processor 208 is structured to process instructions stored in the RAM 206 (or other memory and/or a storage device included with the mobile device 204a) to display graphical information for a user interface.

The RAM 206 on the mobile device 204a includes a mobile application 210 that requests ads. The mobile application 210 sends ad requests 212 into the network 214 (e.g., the Internet or other network). The ad requests 212 go to a server system 216 that includes the ad system 230. In some implementations, the ad requests 212 first go to another system (e.g., a publisher system) that then requests ads on behalf of the mobile application 210.

The server system 216 can be one or more server devices in one or more locations. The server system 216 includes a memory device 218, which can include the ad system 230. A processor 220 is structured to process instructions within the server system 216. These instructions can implement one or more components of the ad system 330. The processor 220 can be a single or multi-threaded processor and can include multiple processing cores. The processor 220 can process instructions stored in the memory 218 related to the ad system 230 and can send information to the mobile devices 204a-c, through the network 214, to create a graphical presentation in a user interface of the particular mobile device of mobile devices 204a-c (e.g., an ad displayed in a mobile application).

The ad system 230 can include a candidate ad engine 220 that identifies candidate ads from an ad repository 222. The ad repository includes ads (e.g., provided by advertisers) and keywords or other instructions or information for serving the ads (e.g., bid amounts, regional targeting information, and the like). The candidate ad engine 220 creates a score for each candidate ad identified, for example, based on whether keywords associated with the candidate ad match keywords associated with an ad request. The ad system 230 can include a score adjustment engine 224. The score adjustment engine 224 can adjust the scores of the candidate ads based on, for example, performance signals gathered from usage information 226. The usage information 226 includes, for example, click-through rates and conversion rates for advertisements in the ad repository 222. The ad system 230 can also include an ad selection engine 228. The ad selection engine 228 typically selects one or more of the highest scoring candidate ads after their scores have been adjusted.

The ad system 230 sends the selected ads 232 to the mobile device 204a where the ads are stored with the RAM 206 and/or used by the processor 208 to display the ads on an output device for the user 202a. In some implementations, when the user 202a interacts with an ad (e.g., clicks the ad or makes a purchase after clicking the ad), the mobile device 204a sends usage information 234 to the ad system 230. The ad system 230 can include the usage information in usage information storage 226.

The components shown in FIG. 2 can be combined in various manners and implemented in various system configurations. For example, the candidate ad engine 220 and the score adjustment engine 224 can be combined into a single component on the ad system 230.

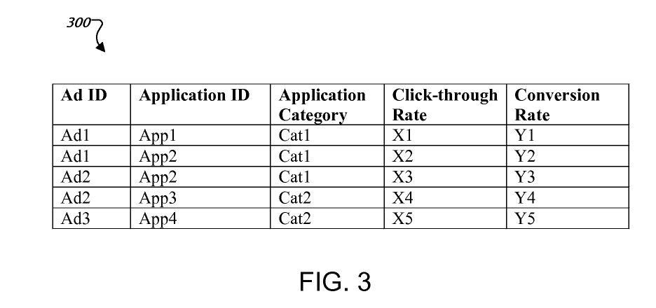

FIG. 3 shows a table 300 illustrating an example collection of performance signals. Each row in the table 300 represents an ad (e.g., according to an ad identifier) and an application (e.g., according to an application identifier) to which the ad can be served. The ad is served to mobile devices that are running the application. For example, the first row represents “Ad1” and “App1.” When Ad1 has been previously served to App1, Ad1 has achieved a click-through rate (CTR) of X1 and a conversion rate of Y1. Based on the second row, when Ad1 has been previously served to App2, Ad1 has achieved a CTR of X2 and a conversion rate of Y2.

Applications can be associated with one or more categories. In some implementations, the categories are related to types of content presented by the application.

For example, an application can be associated with a “sports” category and a “news” category. In some implementations, the categories are related to other aspects of the application, for example, whether the application runs in the background or the foreground, whether the application is location-based, and so on. Performance signals can be based on categories that are associated with applications.

To determine a performance signal for Ad1 in a particular category “Cat1,” a system can use (e.g., compute a sum, mean, or other combination) performance signals for Ad1 for all applications associated with Cat1. Thus, for the example shown in FIG. 3, Ad1's CTR for Cat1 would be a combination of X1 and X2 because both App1 and App2 are in Cat1.

Performance signals can be stored in different formats or collections and gathered from various sources. The example shown in FIG. 3 is just one example of a collection of performance signals. Various implementations include more information than shown in FIG. 3 (e.g., online conversion rate, offline conversion rate, CTR based on location, and so on).

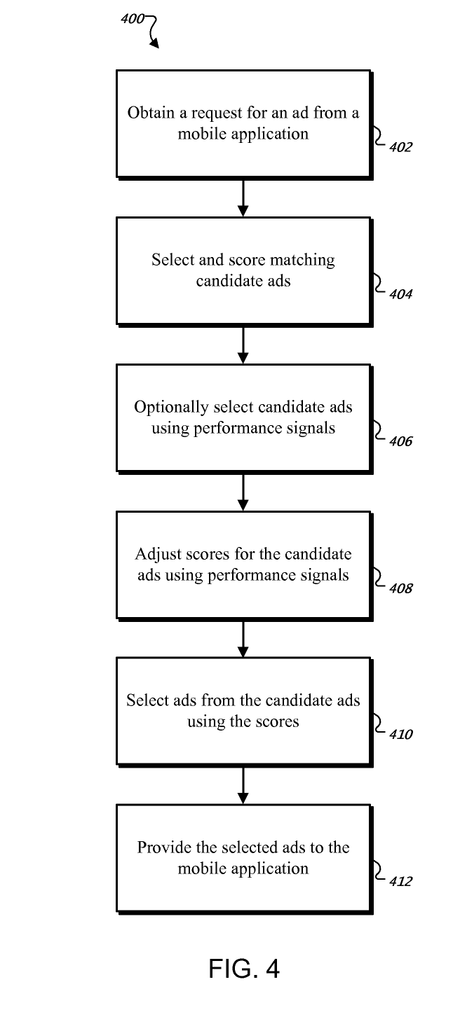

FIG. 4 is flow chart of an example process 400 for selecting an ad for a mobile application using performance signals. In some implementations, the process 400 is performed by a system including one or more computer, e.g., ad system 230 of FIG. 2.

A request for an ad is obtained from a mobile application (step 402). The application can be a stand-alone application or an application executing within a web browser or other software (e.g., as a Javascript or Flash application). Typically, the application requests the ad in response to a user action. For example, the application can request an ad when a user instructs the application to request content or when the application is first opened. Alternatively, the application requests the ad based on other factors. For example, the application can periodically request a new ad to display alongside content that a user is viewing.

The application is associated with one or more categories. In some implementations, the categories are identified using an application store (e.g., a server system that provides applications that can be purchased and downloaded to mobile devices). For example, an application developer can provide the categories to the application store for the application.

In some implementations, the categories are provided by the application developer (e.g., to ad system 230). For example, the application developer can provide keywords for categories. In some implementations, the mobile device running the application can provide the categories (e.g., with the request for an ad). For example, the mobile device can determine a category related to a particular kind of content the user is interacting with (e.g., a category related to news such as finance or international, or a category related to music such as rock or country) and provide that category.

One or more matching candidate ads are selected (step 404). In some implementations, candidate ads are selected from an ad repository (e.g., ad repository 222). In some implementations, candidate ads are selected that match a keyword. For example, the candidate ads can be associated with one or more advertiser-supplied keywords, and matching candidate ads are determined to be associated with keywords that are also associated with the ad request. Keywords can be associated with the ad request, for example, by being associated with the application, or where the keywords are included with the ad request (e.g., by the application). In some implementations, an ad system (e.g., ad system 230) maintains a list of keywords associated with various mobile applications.

In some other implementations, matching candidate ads match other criteria, instead of or in addition to matching a keyword. For example, in some implementation, ads in an ad repository are associated with locations. Matching ads are those ads that are associated with a location that is also associated with the ad request. The ad request can be associated with a location, for example, by being from a user having an associated location provided by an ad system or another system, or where the ad request includes the location (e.g., Global Positioning System (GPS) coordinates from a mobile device).

A score is determined for each of the selected candidate ads. In some implementations, the score is based on how closely the ad matches the ad request. For example, where the ad request is associated with the keywords “national football league,” an ad associated with the keyword “football” can have a higher score than an ad associated with the keyword “sports.” Similarly, in another example, where the ad request is associated with the location “San Francisco,” an ad associated with the location “northern California” can have a higher score than an ad associated with the location “California.”

Performance signals are optionally used to select candidate ads in addition to or instead of the matching candidate ads (step 406). In some implementations, a number of candidate ads with the strongest performance signals (e.g., highest CTR or conversion rate for the application or for a category associated with the application) are selected.

In various implementations, ads are only selected if there is a minimum amount of data for the performance signal being used. For example, where the performance signal being used is an application performance signal (based on performance when the ad was served to the application), ads that have not been served to the application a minimum number of times can be excluded from consideration as a candidate ad. Similarly, in another example where the performance signal being used is a category performance signal, ads that have not been served to applications associated with the category a minimum number of times can be excluded from consideration as a candidate ad.

A score is determined for any candidate ads that were selected using performance signals. In some implementations, a score is based on how closely a candidate ad matches a keyword or another matching criterion, e.g., location.

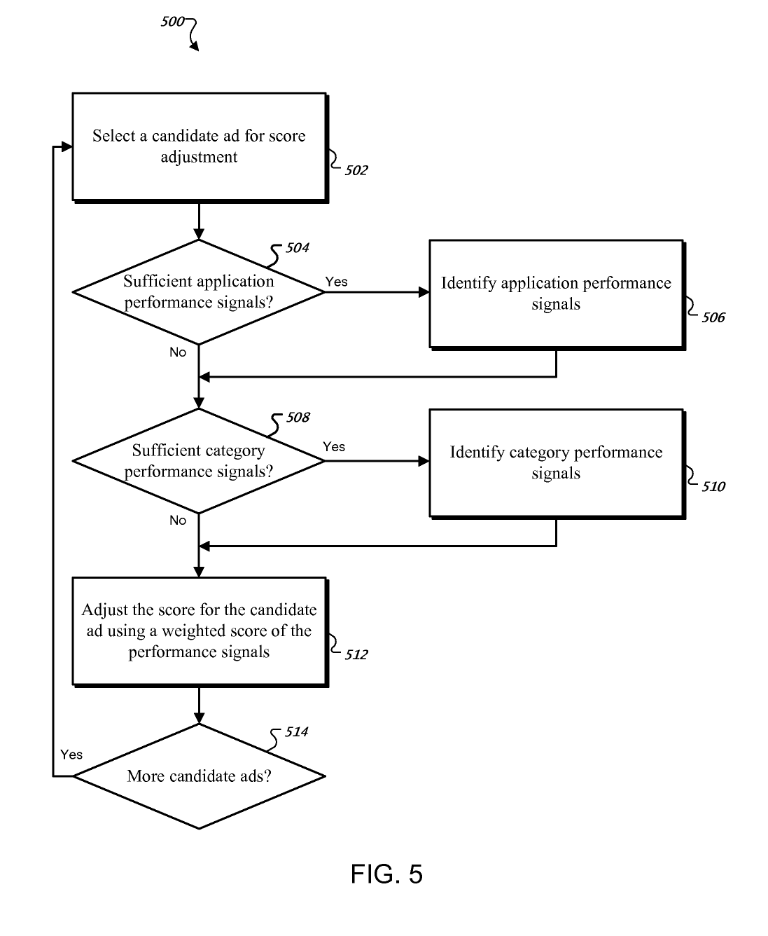

The scores for the candidate ads are adjusted using performance signals (step 408). Various adjustments to the scores are possible. For example, scores can be increased for candidate ads with strong performance signals, and scores can be decreased for candidate ads with weak performance signals, and scores can be maintained (not adjusted) for candidate ads without a minimum amount of data for performance signals. Scores can be increased or decreased by increasing or decreasing variables in a scoring function. Adjusting scores of candidate ads is discussed further with respect to FIG. 5, which depicts an example process for adjusting scores of candidate ads using weighted performance signals.

Using the scores, one or more ads are selected from the candidate ads to provide to the mobile application (step 410). Typically, a number of the highest scoring ads are selected. The number of candidate ads selected can depend on the number of ads requested.

The selected ads are provided to the mobile application (step 412). In some implementations, the selected ads are provided directly to the mobile device running the application (possibly over a network including multiple routers, e.g., the Internet). In some other implementations, the ads are sent to a publisher for incorporation into content prior to sending the content to the mobile application.

FIG. 5 is a flow chart of an example process 500 for adjusting scores of candidate ads to provide to a mobile application using weighted performance signals. In some implementations, the process 500 is performed by a system, e.g., ad system 230.

A candidate ad is selected for score adjustment (step 502). For example, a candidate ad can be selected from a collection of candidate ads identified as described above with respect to FIG. 4.

It is determined whether there are sufficient application performance signals for the candidate ad (step 504). Typically, a number of times that the candidate ad has been served to the application is compared to a minimum number of times, and the performance signals are determined to be sufficient if the number of times exceeds the minimum number of times. Other measures of sufficiency are possible, e.g., whether the candidate ad has been provided to a minimum number of unique users. If the application performance signals are sufficient, the application performance signals are identified (step 506).

It is determined whether there are sufficient category performance signals for the candidate ad (step 508) for a category associated with the application. Typically, a number of times that the candidate ad has been served to applications associated with the category is compared to a minimum number of times, and the performance signals are determined to be sufficient if the number of times exceeds the minimum number of times. Other measures of sufficiency are possible, e.g., whether there are a minimum number of applications associated with the category. If the category performance signals are sufficient, the category performance signals are identified (step 510). If the application is associated with more than one category (e.g., an application that serves user both streaming music and video clips from television shows can be associated with a music category and a video category), performance signals for the other categories can be identified by repeating steps 508 and 510 for the other categories.

The score for the candidate ad is adjusted using a weighted score of the application performance signals and the category performance signals (step 512). In some implementations, the weighted score is weighted based on the amount of data available for application performance signals. For example, for new applications or applications that do not generate large volumes of traffic, there will not be much data available for application performance signals, so the weighted score is weighted more towards category performance signals than application performance signals. In another example, for a popular application that has been in use for a long period of time, there will be plenty of data available for application performance signals, so the weighted score is weighted more towards application performance signals than category performance signals.

In some implementations, where the application is associated with two or more categories, the category performance signal is based on a weighted function of the performance of the content item in each category. The weighted function can be based on how much data is available for each category, how much revenue is associated with each category, and so on. For example, where there is more performance data available for content item when served to applications in a first category than there is for the content item when served to applications in a second category, the function can weigh the data for the first category more heavily than the data for the second category.

The score can be increased for strong performance signals or decreased for weak performance signals. In some implementations, increasing a score includes adding an additional weight to a scoring function or adding a specified amount or percentage to the score. If there are more candidate ads (step 514), the process 500 is repeated for additional candidate ads. If there are no more candidate ads, the modified scores are used to select one or more ads from the candidate ads for presentation.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request to serve a content item to an application on a mobile device, the application being associated with one or more categories;
for each of a plurality of content items in a collection of content items, identifying a performance signal for the content item, the performance signal representing the performance of the content item when served to one or more other mobile devices running the application and one or more other applications associated with one of the one or more categories;
selecting, using one or more processors, a first content item from the plurality of content items based on the performance signals of the plurality of content items; and
providing the first content item to the application on the mobile device.

2. The method of claim 1, wherein:
the first content item is an advertisement.

3. The method of claim 1, wherein:
for at least one content item, the performance signal is based on one or more of: an impression rate, a click-through rate, or a conversion rate.

4. The method of claim 1, wherein:
for at least one content item in the collection, determining that there is insufficient data for a performance signal for the content item and excluding the content item from selection of the first content item.

5. The method of claim 1, wherein:
the performance signal is based on a weighted function of the performance of the content item when served to the other mobile devices running the application and the performance of the content item when served to the other applications associated with the category.

6. The method of claim 5, wherein:
the weighted function is based on how much data is available regarding the performance of the content item when served to the other mobile devices running the application.

7. The method of claim 1, wherein:
the application is associated with first and second categories;
the performance signal is based on a weighted function of the performance of the content item when served to one or more first applications associated with the first category and one or more second applications associated with the second category; and
the weighted function is based on how much data is available regarding the performance of the content item when served to the first applications and the second applications.

8. The method of claim 1, wherein the one or more categories are related to types of content presented by the application.

9. The method of claim 1, further comprising
identifying the one or more categories using an application store, where the one or more categories are provided by an application developer to the application store for the application.

10. The method of claim 1, further comprising:
identifying a keyword associated with the request;
determining one or more candidate content items using the keyword; and
modifying a score of each candidate content item using the performance signal, where selecting the first content item includes selecting the first content item from the candidate content items using the scores for the candidate content items.

11. The method of claim 1, further comprising:
identifying a keyword associated with the request; and
determining one or more candidate content items using the performance signal.

12. A system comprising:
one or more processors configured to interact with a computer storage medium in order to perform operations comprising:
receiving a request to serve a content item to an application on a mobile device, the application being associated with one or more categories;
for each of a plurality of content items in a collection of content items, identifying a performance signal for the content item, the performance signal representing the performance of the content item when served to one or more other mobile devices running the application and one or more other applications associated with one of the one or more categories;
selecting, using one or more processors, a first content item from the plurality of content items based on the performance signals of the plurality of content items; and
providing the first content item to the application on the mobile device.

13. The system of claim 12, wherein:
the first content item is an advertisement.

14. The system of claim 12, wherein:
for at least one content item, the performance signal is based on one or more of: an impression rate, a click-through rate, or a conversion rate.

15. The system of claim 12, wherein:
for at least one content item in the collection, determining that there is insufficient data for a performance signal for the content item and excluding the content item from selection of the first content item.

16. The system of claim 12, wherein:
the performance signal is based on a weighted function of the performance of the content item when served to the other mobile devices running the application and the performance of the content item when served to the other applications associated with the category.

17. The system of claim 16, wherein:
the weighted function is based on how much data is available regarding the performance of the content item when served to the other mobile devices running the application.

18. The system of claim 12, wherein:
the application is associated with first and second categories;
the performance signal is based on a weighted function of the performance of the content item when served to one or more first applications associated with the first category and one or more second applications associated with the second category; and
the weighted function is based on how much data is available regarding the performance of the content item when served to the first applications and the second applications.

19. The system of claim 12, wherein the one or more categories are related to types of content presented by the application.

20. The system of claim 12, further comprising
identifying the one or more categories using an application store, where the one or more categories are provided by an application developer to the application store for the application.

21. The system of claim 12, the operations further comprising:
identifying a keyword associated with the request;
determining one or more candidate content items using the keyword; and
modifying a score of each candidate content item using the performance signal, where selecting the first content item includes selecting the first content item from the candidate content items using the scores for the candidate content items.

22. The system of claim 12, the operations further comprising:
identifying a keyword associated with the request; and
determining one or more candidate content items using the performance signal.

23. A computer storage medium encoded with a computer program, the program comprising instructions that when executed by data processing apparatus cause the data processing apparatus to perform operations comprising:
receiving a request to serve a content item to an application on a mobile device, the application being associated with one or more categories;
for each of a plurality of content items in a collection of content items, identifying a performance signal for the content item, the performance signal representing the performance of the content item when served to one or more other mobile devices running the application and one or more other applications associated with one of the one or more categories;
selecting, using one or more processors, a first content item from the plurality of content items based on the performance signals of the plurality of content items; and
providing the first content item to the application on the mobile device.
